(19) United States
(12) Patent Application Publication
(10) Pub. No.: US 2002/0127396 A1
(43) Pub. Date: Sep. 12, 2002

(54) Adhesive tapes

(76) Inventors: Manfred Spies, Bad Bramstedt (DE); Zygmunt Kozaczka, Hamburg (DE)

Correspondence Address: Christa Hildebrand, Norris McLaughlin & Marcus, 30th Floor, 220 East 42nd Street, New York, NY, 10017, US

(21) Appl. No.: 10/043,670

(22) Filed: Jan. 11, 2002

(30) Foreign Application Priority Data
Jan. 13, 2001 (DE) 101 01 335.3

(51) Int. Cl. B32B 7/12; B32B 15/04

(52) U.S. Cl. 428/355 BL; 428/356; 428/343

(57) ABSTRACT

An adhesive tape having a backing and an adhesive composition, wherein the adhesive composition is a styrene-butadiene dispersion having a butadiene content of more than 55% in a blend with natural rubber latex and has been coated onto the backing and then dried.

The invention relates to the development of pressure sensitive adhesive tapes comprising cohesive composition systems based on styrene-butadiene latices of high butadiene content and natural rubber latex.

The conventional adhesive composition systems for pressure sensitive adhesive tapes are based substantially on natural rubber, styrene block copolymers, and polyacrylates. For applications where reversible behavior is a specific requirement, ethylenevinyl acetates or polyisobutylenes are also appropriate.

Styrene-butadiene latices have been used for many years in the pressure sensitive adhesives (PSA) field for impregnating and stabilizing backing materials. Papers, wovens, and nonwovens are in the foreground in this case. Because of the application, the impregnation or coating must absolutely not be tacky. The styrene-butadiene copolymers used for this application are therefore required to contain a relatively high fraction of hardening monomers while including sufficient softening monomer so that the copolymer overall is still elastic. Styrene-butadiene latices having a butadiene content of about 25-55% comply very well with this requirement. Films of these copolymers, depending on the butadiene content, are moderately elastic to elastic, and are nontacky. Such copolymers have been available on the base materials market for many years (Butofan® grades from BASF, and various grades from Dow and Synthomer). Because of their preparation, such latices and dispersions include emulsifier systems to produce compatibility between the organic phase and the aqueous phase.

In the past, styrene-butadiene copolymers have also been used as base polymers for label compositions. In the labels sector, cohesion is often of secondary importance, so that the properties of weakly adhering systems are in many cases adequate after they have been compounded with customary tackifiers (resin dispersions).

Styrene-butadiene copolymers have also been used in combination with natural rubber latices. An overview of this can be found in Donatas Satas, Handbook of Pressure Sensitive Adhesive Technology, 3rd Edition, Natural Rubber Adhesives by G. L. Butler (pp. 276-283).

Osari in EP 95108577 describes the use of aqueous emulsions based on natural rubber latex for producing pressure sensitive adhesive tapes. The addition of styrene-butadiene dispersions having a customary butadiene content (in the range of about 25-55%) serves here primarily to stabilize the shear-unstable natural rubber latex and to set the viscosity.

The suitability of customary styrene-butadiene copolymers with a butadiene content of between 25 and 55% as framework polymers for cohesive PSA compositions is poor, since they always have to be made tacky using tackifier resins, in amounts which are considerable in some cases, and this is associated with a far-reaching loss of cohesion. This prevents their use for adhesive tapes for which cohesive adhesive compositions are needed.

Owing to the polymer structure and pricing level, however, styrene-butadiene copolymers are fundamentally of interest as framework polymers for demanding PSA compositions.

It was an object of the invention to remedy this situation and to provide a styrene-butadiene-based adhesive composition which does not have the drawback of low cohesion and which can be used to make a pressure sensitive adhesive tape very suitable, inter alia, for reversible applications.

This object has been achieved by the use of a styrene-butadiene dispersion of high butadiene content which has been blended with natural rubber latex. The resulting compound may be admixed, if desired, with further coagents, such as aging inhibitors, UV stabilizers, fillers or emulsifiers, for example, in order to tailor further the protection against aging and the adhesion data to the application. After the adhesive composition has been coated onto a polymer or paper backing, a pressure sensitive adhesive tape is obtainable which meets the requirements for an adhesive tape having cohesive properties and which is suitable, for example, for reversible applications. Products of this kind may be employed in the field of surface protection. Furthermore, this prevents adverse effects on the cohesion of the adhesive compositions caused by tackifier resins. Residues caused by tackifier resins, as well, are therefore prevented during the detachment.

Adhesive Compositions

The homopolymerization of styrene in an aqueous medium gives polymers whose high Tg gives them a very restricted importance even for paint applications. The copolymerization of styrene with about 35-45% butadiene in an aqueous medium gives copolymers which are film forming and in which a minimum film formation temperature of about 0° C. is achievable, so that these systems can be used in the sectors of priming, painting, binders, and general modification. The styrene-butadiene dispersions are generally stabilized by incorporating small amounts of carboxyl groups, which at the same time improves the adhesion to many substrates.

As adhesive compositions for the invention it is possible in particular to use carboxylated styrene-butadiene copolymer dispersions having a butadiene fraction of 55-95%, preferably 60-85%, based on the total solids fraction of styrene and butadiene, which in a mixture with natural rubber latex exhibit outstanding suitability as adhesive compositions for reversible adhesive tapes. Carboxylated copolymers of this kind contain in particular less than 10%, preferably less than 5%, based on the monomer content, of carboxyl comonomer, especially acrylic acid, in the copolymer.

Styrene-butadiene dispersion grades in accordance with the invention, having a butadiene content>60%, are available, for example, from Dow.

As the natural rubber latex component, both low ammonia latices and high ammonia latices are suitable. Latices of the low ammonia type are preferred. Based on the total solids content of styrene-butadiene copolymer and natural rubber latex, the natural rubber fraction should be in the range 5-80%, preferably 20-50%. For tailoring the adhesive properties it is also possible to use mixtures of different natural rubber latices. In order to improve the aging behavior it is possible to add dispersions of customary aging inhibitors and UV stabilizers, which are well known from the field of the elastomers.

It is also possible, where necessary, to add further additives for adapting the properties of the product, such as, for example, fillers or emulsifiers of the alkoxylated alkylphenol type, for example. These additives make it possible to exert further, desired influence over the adhesive properties. Where necessary, the adhesion/cohesion balance may be set by chemical crosslinking via the carboxyl groups present, by means of added crosslinking agents such as aluminum chelate or titanium chelate, for example. In contrast to many styrene block copolymers, radiation crosslinking is likewise possible owing to the sufficiently high molecular weight.

The adhesive composition application rate is 10-120 g/m², preferably 15-40 g/m².

Backing Materials

All customary backing materials are suitable for the invention. They substantially include films and papers whose properties and whose production and/or aftertreatment process gives them the required mechanical application properties.

In the case of the films, suitable materials substantially include polyethylene, polypropylene, polyvinyl chloride, polyesters, and other polymers and copolymers customary for the application, which may be used in single-layer or multilayer form. In multilayer systems, the composition and the thickness of the individual layers may also vary.

Both blown film and flat film may be used.

The thicknesses of the films are between 10 and 250 μm, preferably between 20 and 120 μm.

In order to ensure sufficient adhesion of the adhesive composition on the backing material, the surface energy on the side that is to be coated must be situated within a defined range. This may be ensured either by additional coating with a primer or by a surface treatment. Preference is given to a corona or flame pretreatment by means of which the desired surface energies may be achieved. The surface energies should be in a range of 25-50 mN/m, preferably 30-45 mN/m.

Further suitable backing materials include impregnated and highly sized papers with defined creping, having tensile strengths which satisfy the desired requirements. Depending on the desired application, it is possible to use both papers with greater machine direction stretchability than cross direction stretchability and papers with greater cross direction stretchability than machine direction stretchability, in both bleached and environment-friendly unbleached versions.

All percentages are by weight.

### EXAMPLES

### Example 1

A dispersion adhesive composition composed of 75% of a carboxylated styrene-butadiene dispersion having a butadiene content of more than 70% (XZ 91979.00, styrene-butadiene dispersion from Dow) and 25% of natural rubber latex (low ammonia centrifuge latex) is coated continuously with a layer thickness of 25 g/m² onto a polyester film, using a wire doctor. The percentages are based on the solids content.

Technical conditions:

| | |
|---|---|
| Machine: | pilot coating plant |
| Applicator: | wire doctor |
| Backing web speed: | 3.5 m/min |

The coating material is subsequently dried thermally:

| | |
|---|---|
| Drying (suspension nozzle drier): | zone 1: 100° C. |
| | zone 2: 120° C. |

The bale material is then cut into rolls.

Technical data (fresh state):

Bond strength/steel: 1.2 N/cm

Shear stability/steel (13×20 mm, 1 kp):>20 000 min

Microshear path (40° C., 3N): 7 μm

Thermoshear path (5° C./min, 3N, in ° C.):>200° C.

### Example 2

A dispersion adhesive composition composed of 50% of a carboxylated styrene-butadiene dispersion having a butadiene content of more than 70% (XZ 91979.00, styrene-butadiene dispersion from Dow) and 50% of natural rubber latex (low ammonia centrifuge latex) is coated continuously with a layer thickness of 25 g/m² onto a polyester film, using a wire doctor. The percentages are based on the solids content.

Technical conditions:

| | |
|---|---|
| Machine: | pilot coating plant |
| Applicator: | wire doctor |
| Backing web speed: | 3.5 m/min |

The coating material is subsequently dried thermally:

| | |
|---|---|
| Drying (suspension nozzle drier): | zone 1: 100° C. |
| | zone 2: 120° C. |

The bale material is then cut into rolls.

Technical data (fresh state).

Bond strength/steel: 0.55 N/cm

Shear stability/steel (13×20 mm, 1 kp):>20 000 min

Microshear path (40° C., 3N): 5 μm

Thermoshear path (5° C./min, 3N, in ° C.):>200° C.

What is claimed is:

1. An adhesive tape having a backing and a cohesive adhesive composition, wherein the adhesive composition is a styrene-butadiene dispersion having a butadiene content of more than 55% in a blend with natural rubber latex and has been coated onto the backing and then dried.

2. The adhesive tape as claimed in claim 1, wherein the natural rubber latex may be either of the low ammonia or of the high ammonia type.

3. The adhesive tape as claimed in claim 1, wherein mixtures of different styrene-butadiene types and natural rubber latex types may also be used.

4. The adhesive tape as claimed in claim 1, wherein the adhesive composition is chemically crosslinkable by means of added customary crosslinkers (e.g., aluminum chelate or titanium chelate, further metal complexes, isocyanates, epoxy, etc.).

5. The adhesive tape as claimed in claim 1, wherein the adhesive composition is physically crosslinkable, in particular by means, for example, of EBC.

6. The adhesive tape as claimed in claim 1, wherein the aging stability may be improved by adding aging inhibitors and UV stabilizers.

7. The adhesive tape as claimed in claim 1, wherein the backing is a polyolefin, polyester, PVC or paper.

8. The adhesive tape as claimed in claim 1, wherein the application rate of the adhesive composition is 10-120 g/m².

9. The adhesive tape as claimed in claim 1, wherein to improve the anchoring of the composition the backing is physically surface treated or is pretreated with a primer.

10. The adhesive tape as claimed in claim 1, wherein the styrene-butadiene dispersion is of the type of a carboxylated styrene-butadiene dispersion.

11. The adhesive tape as claimed in claim 1, wherein the fraction of natural rubber latex is in the range 5-80%, in particular 20-50%, based on the total solids content.

12. The use of the adhesive tape with a cohesive adhesive composition as claimed in any of claims 1-10 for, for example, reversible applications.

13. The use of adhesive compositions free from tackifier resin to increase the cohesion in an adhesive tape as claimed in any of claims 1-10.
